(19) United States
(12) Patent Application Publication
(10) Pub. No.: US 2014/0325641 A1
(43) Pub. Date: Oct. 30, 2014

(54) METHOD AND APPARATUS FOR FACE RECOGNITION

(71) Applicant: SUPREMA INC., Seongnam-si (KR)

(72) Inventors: Bo Gun Park, Seongnam-si (KR); Ki Deok Lee, Seongnam-si (KR); Ho chul Shin, Seongnam-si (KR); Bong Seop Song, Seongnam-si (KR); Jae Won Lee, Seongnam-si (KR)

(73) Assignee: SUPREMA INC., Seongnam-si (KR)

(21) Appl. No.: 14/140,396

(22) Filed: Dec. 24, 2013

(30) Foreign Application Priority Data
Apr. 25, 2013 (KR) 10-2013-0045826

(51) Int. Cl. G06F 21/32; G06K 9/00

(52) U.S. Cl. CPC G06F 21/32; G06K 9/00288
USPC 726/19

(57) ABSTRACT

An apparatus for a face recognition, includes an ID assigning unit configured to assign one ID to a user when registering the user so that the ID is mapped to the user; and a sub-ID assigning unit configured to respectively assign sub-IDs to face images of the user which are different from each other so that the sub-IDS are respectively mapped to the face images when the face images are registered. Further, the apparatus includes a mapping table creation unit configured to create a mapping table in which pairs of the ID and the respective sub-IDs are mapped; and an authentication unit configured to search the mapping table to authenticate the user to provide an authentication result, upon receipt of a request of a user authentication.

### CROSS-REFERENCE TO RELATED APPLICATION(S)

The present invention claims priority of Korean Patent Application No. 10-2013-0045826, filed on Apr. 25, 2013, which is incorporated herein by reference.

### FIELD OF THE INVENTION

The present invention relates to an apparatus and method for face recognition; and more particularly, to an apparatus and method for face recognition, capable of performing adaptive face recognition in spite of the changes in the facial expression by assigning a plurality of sub-IDs to one user.

### BACKGROUND OF THE INVENTION

Recently, there has been a growing tendency to strengthen the security of companies or enterprises using facial recognition as the importance of the security increases. In conducting face authentication by using a face recognition device, such factors as the changes in hairstyle, whether to wear glasses, the lapse of a long time since a face image of a person to be authenticated is registered, and the like act as causes that reduces the face recognition performance, along with lighting and posture change.

Among them, in an effort of minimizing the facial misrecognition of a man in glasses, there is proposed a method to shoot the face of the user who wears glasses and the face of the user who does not wear glasses. Further, in the related art, there has been disclosed a method in which face images of a user who wears and does not wear glasses are registered and these images of the user are compared for the user identification.

However, in a face recognition method, it is still hard to adaptively recognize the face of a user that changes as time passes. In such a case, the user should register his/her face to be authenticated with different ID again. If that is the case, the user undergoes once again the procedure to determine whether the user is the same one who has already been registered. As such, even though the user is the same one who has already been registered, the user receives the same procedure of the face recognition as to be applied to others. Therefore, this causes an increased load and time taken to perform the face recognition, which results in lowering the face recognition performance.

### SUMMARY OF THE INVENTION

In view of the above, the present invention provides an apparatus and method for face recognition, which is capable of enhancing face recognition performance by way of assigning one ID to the same user and registering a plurality of different images of the user in their corresponding sub-IDs. However, the technical problem of the embodiment is not limited to the aforementioned technical problem, and other technical problems may be provided as well.

In accordance with a first aspect of the present invention, there is provided an apparatus for a face recognition. The apparatus includes: an ID assigning unit configured to assign one ID to a user when registering the user so that the ID is mapped to the user; a sub-ID assigning unit configured to respectively assign sub-IDs to face images of the user which are different from each other so that the sub-IDS are respectively mapped to the face images when the face images are registered; a mapping table creation unit configured to create a mapping table in which pairs of the ID and the respective sub-IDs are mapped; and an authentication unit configured to search the mapping table to authenticate the user to provide an authentication result, upon receipt of a request of a user authentication.

In accordance with a second aspect of the present invention, there is provided a method for face recognition. The method includes: assigning one ID to a user when registering the user so that the ID is mapped to the user;

assigning sub-IDs to face images of the user which are different from each other respectively so that the sub-IDS are respectively mapped to the face images when the face images are registered; creating a mapping table in which pairs of the ID and the respective sub-IDs are mapped; and authenticating the user as the registered user to provide an authentication result by searching the mapping table, upon a receipt of a request of a user authentication.

In accordance with any one aspect of the aforementioned technical solutions of the embodiments, it is possible to adaptively recognize faces in spite of the changes in hairstyle, whether to wear glasses and the changes in facial expression due to the lapse of a long time. Further, the registered face images for the user having different sub-IDs are not dealt with as those of other persons. When these face images are used to recognize the user, the embodiment calculates the degree of matching for each of the face images having the sub-IDs or the degree of matching for all the face images having the sub-IDs, so that the face images having the sub-IDs can be recognized differently of the registered images to which separate IDs are assigned.

### BRIEF DESCRIPTION OF THE DRAWINGS

The above and other objects and features of the present invention will become apparent from the following description of the embodiments given in conjunction with the accompanying drawings, in which:

FIG. 1 is a configuration diagram of a system for face recognition in accordance with an embodiment of the present invention;

FIG. 2 is a block diagram of the face recognition service apparatus shown in FIG. 1;

FIG. 3A is various face images of a user who wears or does not wear glasses that are registered with different sub-IDs;

FIGS. 3B and 3C shows screens on the face registration terminal or the face recognition terminal shown in FIG. 1; and

FIG. 4 is a flow chart illustrating a method of providing a face recognition service in accordance with an embodiment of the present invention.

### DETAILED DESCRIPTION OF THE EMBODIMENTS

Hereinafter, the embodiments of the present invention will be described in detail with reference to the accompanying drawings which form a part hereof.

Throughout the specification and the claims, when an element is described as being “connected” to another element, this implies that the elements may be directly connected together or the elements may be connected through one or more intervening elements. Furthermore, when an element is described as “including” one or more elements, this does not exclude additional, unspecified elements, nor does it preclude the presence or addition of one or more other features, integers, steps, operations, elements, components and/or groups thereof.

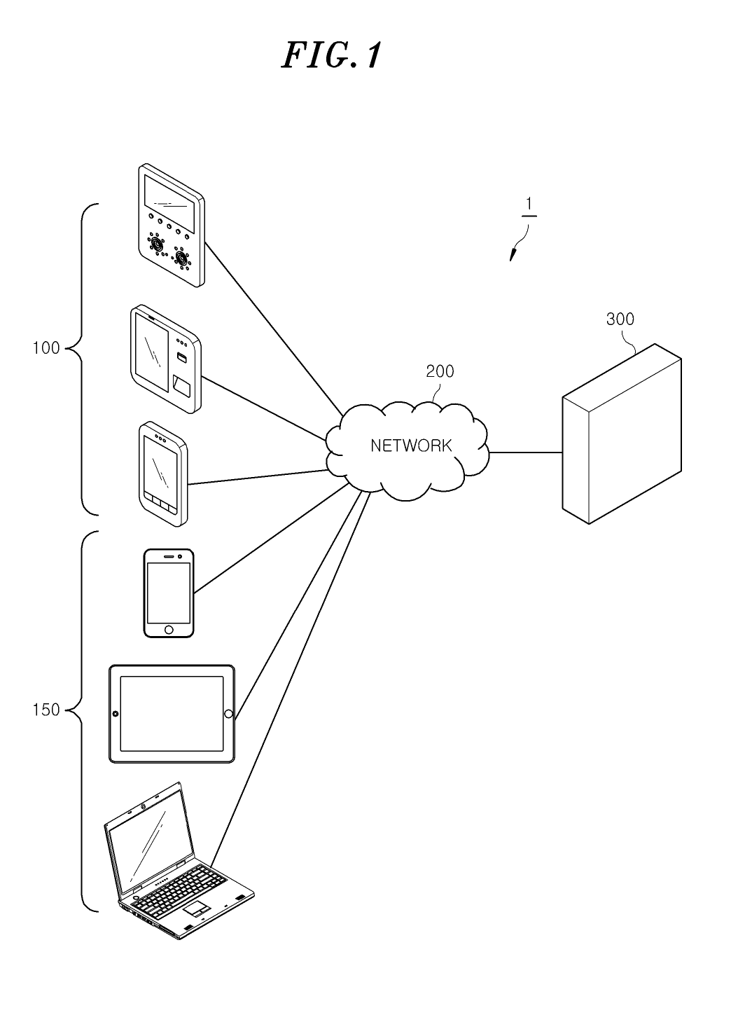

FIG. 1 is a configuration diagram illustrating a system for face recognition in accordance with an embodiment of the present invention.

Referring to FIG. 1, a system for a face recognition 1 includes a face recognition terminal 100, a face registration terminal 150, and a face recognition service apparatus 300. In this regard, the system for a face recognition service is merely an exemplary embodiment of the present invention; therefore, the present invention is not limited thereto.

All of the components shown in FIG. 1 may be connected altogether via a network 200. For example, as illustrated in FIG. 1, the face recognition terminal 100 and the face registration terminal 150 may be connected with each other via the network 200. Further, the face recognition service apparatus 300 may also have the connection with the face recognition terminal 100 and the face registration terminal 150 via the network 200. Further, the face recognition terminal 100, the face registration terminal 150 and the face recognition service apparatus 300 are not limited to those illustrated in FIG. 1.

The network 200 refers to a connection topology that enables information exchange between nodes such as terminals, servers, etc. The network may be the Internet, LAN (Local Area Network), Wireless LAN (Wireless Local Area Network), WAN (Wide Area Network), PAN (Personal Area Network), 3G network, 4G network, LTE network, Wi-Fi network, or the like, but is not limited thereto. Further, the face recognition terminal 100, the face registration terminal 150, and the face recognition service apparatus 300 are not limited to those illustrated in FIG. 1.

The face recognition terminal 100 and the face registration terminal 150 may be integrated in one terminal having a combined face registration and face recognition capability. In addition, the face recognition service apparatus 300 may also be implemented in the same type of the face recognition terminal 100 or the face registration terminal 150. The face recognition terminal 100, the face registration terminal 150 and the face recognition service apparatus 300 may, for example, be a mobile telephone, a smartphone, a laptop computer, a personal digital assistant (PDA), a digital graphics tablet, a communicating monitor, or a communicating gaming console, as illustrated in FIG. 1, but are not limited thereto.

Hereinafter, the method of providing the face recognition service of the embodiment will be described by way of example below.

In a face recognition technology, the changes in hairstyle, whether to wear glasses, the lapse of long time since a face image of a person to be authenticated is registered, or the like is one of the factors that degrades the performance of the face recognition, along with lighting and posture change. In order to overcome the defects as described above, there is a need for various face recognition techniques to extract a robust characteristic against the changes in hairstyle and whether to wear glasses, or to compensate the changes in the face image itself. Nonetheless, these techniques require a complicated computational task and exhibit limited performance; therefore, it is hard to be substantially applied to an actual face recognition system.

In practice, if this is the case, a typical face recognition system substantially assigns different IDs to one user and repeatedly performs the same identification procedure for each ID so as to register the user. Therefore, the user undergoes repetitively the procedure to determine whether the user is the same one who has already been registered. Further, it is not easy to manage the procedure, and the user also receives the same procedure of the face recognition as to be applied to others. In addition, when different IDs are registered, the images having the different IDs are recognized independently for each ID, which results in lowering the face recognition performance.

Therefore, in order to overcome the aforementioned problems due to the changes in hairstyle, whether to wear glasses, and the lapse of the long time when performing the face recognition, the embodiment of the present invention provides a method for face recognition, capable of improving the face recognition performance by way of assigning one ID to one user and registering a plurality of different face images of the user with their corresponding sub-IDs. Accordingly, the embodiment of the present invention does not deal with the registered face images for the user having different sub-IDs as those of individual persons. When these face images are used to recognize the user, the embodiment calculates the degree of matching for each of the face images having the sub-IDs or the degree of matching for all the face images having the sub-IDs, so that the face images having the sub-IDs can be recognized differently of the registered images to which separate IDs are assigned.

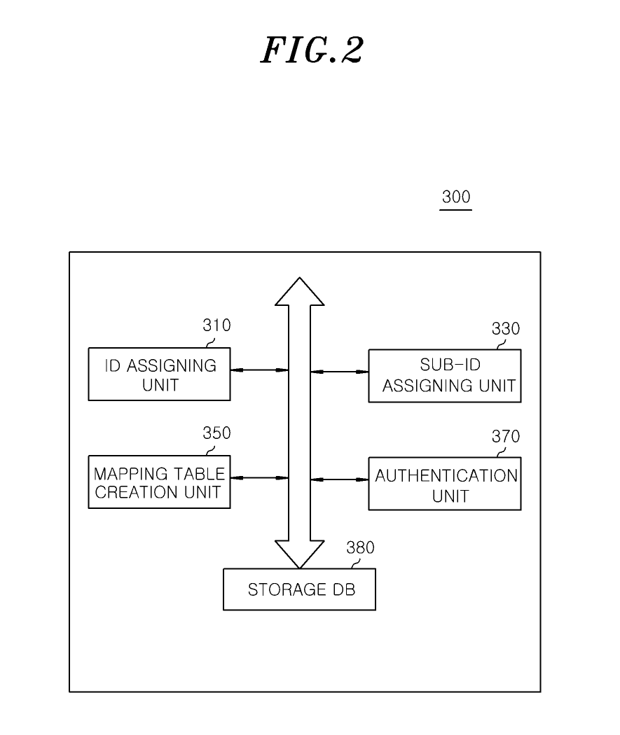

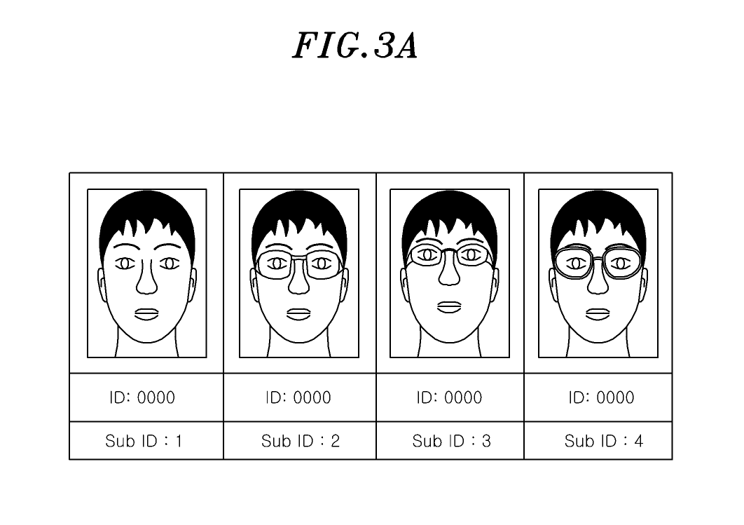

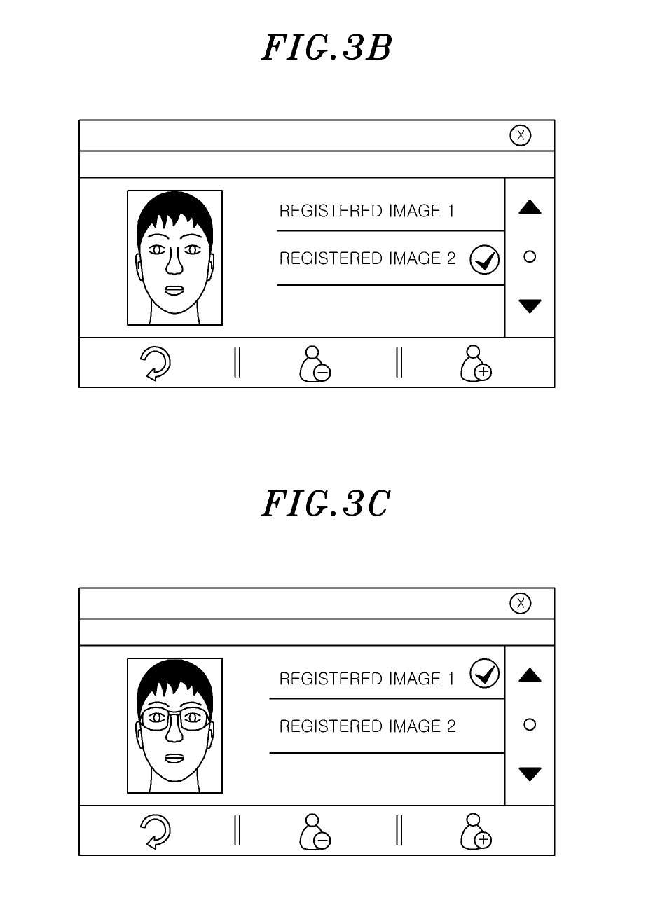

FIG. 2 is a block diagram of the face recognition service apparatus shown in FIG. 1; FIG. 3A is various face images of a user who wears or does not wear glasses that are registered with different sub-IDs; and FIGS. 3B and 3C show screens on the face recognition terminal 100 or the face registration terminal 150 shown in FIG. 1

Referring to FIG. 2, the face recognition service apparatus 300 includes an identification (ID) assigning unit 310, a sub-ID assigning unit 330, a mapping table creation unit 350, and an authentication unit 370.

The ID assigning unit 310 assigns one ID to a user so that the ID can be mapped to the user when the user registers his/her face image in the face recognition service system for the first time through the face registration terminal 150. During the ID assignment, the user may directly assign the ID through the face registration terminal 150, or the ID assigning unit 310 may assign the ID automatically.

The sub-ID assigning unit 330 respectively assigns one sub-ID to each of the various face images of the user so that the respectively assigned sub-ID can be mapped to each of the face images when the face image is registered for the first time in the face recognition service system through the interface provided by the face recognition terminal 100 or the face registration terminal 150.

When the user wishes to additionally register his/her additional face image(s), the sub-ID assigning unit 330 assigns additional sub-ID(s) to the additional face image(s) of the user so that the additional sub-ID(s) can be mapped to the additional face image(s).

The additional face image(s) may, for example, be the face image(s) of the user who wears glasses or sunglasses, whereas the face image that is registered for the first time may be the face image of the user who does not wear glasses or sunglasses, or vice versa. In the embodiment, the face image that is registered for the first time will be referred to as a primary face image of the same user, and the additional face image(s) will be referred to as a subsidiary face image(s) of the same user.

Similarly to the ID assignment, the user may directly assign the sub-ID through the face registration terminal 150, or the sub-ID assigning unit 310 may assign the sub-ID automatically. As an example, the ID and the sub-ID may be assigned through a user interface provided by the face recognition terminal 100 or the face registration terminal 150.

A process of assigning the sub-ID will be illustrated with reference to FIG. 3A. Assuming that a user has an ‘ID 0000’, a primary face image of the user without any blocking component such as glasses, that is without wearing any glasses, may be assigned to a sub-ID ‘1’. Further, additional three subsidiary face images may be assigned to sub-IDs, 2, 3, and 4, respectively. Accordingly, referring to FIGS. 3B and 3C, it can be seen that a user has a number of images that are registered. That is to say, one ID is given to the same user, a plurality of sub-IDs is given to the one ID, and the face images of the same user are registered with the sub-IDs, respectively.

The mapping table creation unit 350 creates a mapping table in which the ID and the sub-ID are paired for each face image of the same user.

As set forth above, since the ID and the sub-ID for each face image have the relation of one-to-one correspondence, one ID per one user and N-number of sub-IDs per one ID can be assigned.

The authentication unit 370, upon receipt of a request of user authentication from the face recognition terminal 100, searches the mapping table to authenticate the user and outputs the authentication result through the face recognition terminal 100.

As mentioned above, the face recognition service apparatus 300 may be implemented in the form of the face recognition terminal 100 or the face registration terminal 150, the face recognition terminal 100 and the face registration terminal 150 may be integrated in one terminal. Therefore, unless otherwise independently provided, the functionality of the face recognition service apparatus 300 may be practiced by the face recognition terminal 100 or the face registration terminal 150.

A way of performing the face recognition by the authentication unit 370 may be divided into three methods. In a first method, a subject face image that is requested for the user authentication is compared to the respective face images that are mapped to pairs of the ID and sub-ID, that is to say, which have been registered, and a similarity measurement is performed on the subject face image and the respective face images that have been registered.

In a second method, a representative face image is selected among the face images that are mapped to pairs of the ID and sub-ID and a similarity measurement is performed on the representative face image and the subject face image. In a third method, a sub-space is formed using the face images that are mapped to pairs of the ID and sub-ID and a similarity measurement is performed by calculating the distance to the subject face image.

That is, the first method compares the face images that are mapped to pairs of the ID and sub-ID and the subject face image that is requested for the user authentication by the authentication unit 370 to measure the similarity between the face images and the subject face image. Further, the authentication unit 370 selects a similarity having the largest value, compares the largest similarity value to a predetermined threshold similarity value, and authenticates that the user is the registered user when the largest similarity value is equal to or greater than the predetermined threshold similarity value.

Alternatively, the authentication unit 370 compares the face images that are mapped to pairs of the ID and sub-ID and the subject face image that is requested for the user authentication to measure the similarities between the face images and the subject face image, as described above. The measured similarities are then weighted and normalized. Thereafter, the normalized similarities are compared with a predetermined threshold similarity value, to authenticate that the user is the registered user when at least one of the normalized similarities is equal to or greater than the predetermined reference similarity value.

In the second method, the authentication unit 370 chooses a representative face image among the face images that are mapped to the pairs of the ID and sub-ID and the face image that is requested for the user authentication. After that, the authentication unit 370 compares the representative face image and the subject face image that is requested for the user authentication to measure the similarity between the face images and the subject face image. With this configuration, a set of the face images that belong to one user can be authenticated as those of the same user.

In the third method, the authentication unit 370 uses at least one subspace technique of PCA (Principal Component Analysis), LDA (Linear Discriminant Analysis), ICA (Independent Component Analysis), and the like to authenticate the user. As an example, the authentication unit 370 may create a subspace with respect to the face images of the user that are registered based on the PCA. When there is a request for the user authentication, the authentication unit 370 calculates a distance between the subspace and the subject face image of the user that is requested for the user authentication.

Thereafter, the authentication unit 370 authenticates the user in accordance with the calculated distance. The creation of the subspace using the PCA is well known in the art and details thereof will not be described any more.

In accordance with the embodiment of the present invention, in order to overcome the face changes due to the changes in hairstyle, whether to wear glasses, a lapse of a long time, the method for face recognition is provided, which capable of improving face recognition performance, by assigning one ID to a user and registering a plurality of face images of the user with separate sub-IDs. Accordingly, the embodiment of the present invention does not deal with the registered face images for the user having different sub-IDs as those of other persons. When these face images are used to recognize the user, the embodiment calculates the degree of matching for each of the face images having the sub-IDs or the degree of matching for all the face images having the sub-IDs, so that the face images having the sub-IDs can be recognized differently of the registered images to which separate IDs are assigned.

Further details of the method of providing a face recognition service illustrated in FIGS. 2, 3A to 3C will not be described since the similar or identical description has already been made with reference to FIG. 1 and can be inferred from that description.

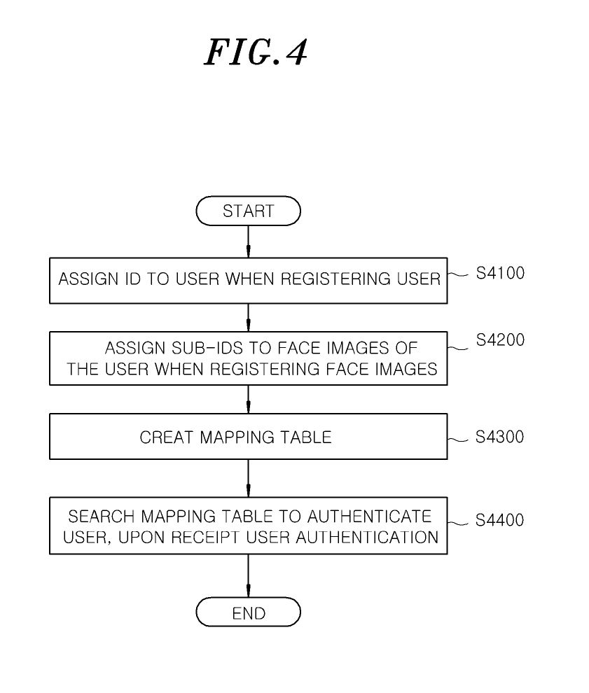

FIG. 4 is a flow chart illustrating a method of providing a face recognition service in accordance with an embodiment of the present invention.

When a face image of a user is registered through the face registration terminal for the first time, the face recognition service apparatus 300 assigns one ID to the user so that the ID is mapped to the user in operation S4100.

Next, in operation S4200, the face recognition service apparatus 300 assigns a sub-ID to the face image of the user, i.e., a primary face image so that the sub-ID is mapped to the primary image. Further, when another face image of the user, i.e., one or more subsidiary faces are provided through an interface provided by the face recognition terminal 100 or the face registration terminal 150, the face recognition service apparatus 300 additionally assigns separate sub-IDs to the subsidiary face images of the user so that the subsidiary sub-IDs can be mapped to the subsidiary face images.

Subsequently, the face recognition service apparatus 300 creates a mapping table in which the ID and the sub-IDs are paired for each face image of the same user, in operation S4300.

Afterwards, when receiving a request for user authentication from the face recognition terminal 150, the face recognition service apparatus 300 searches the mapping table to authenticate the user and sends the authentication result to the face registration terminal 150, in operation S4400.

In accordance with an embodiment of the present invention, one user is assigned with N numbers of sub-IDs, and the face images of the user are registered with the sub-IDs, which are recognized as those of the same person. In order to implement the registration of the N numbers of sub-IDs, the face registration terminal and the face recognition terminal may provide a user interface such as several menus to perform the face registration and recognition service, and the face recognition service apparatus may be provided with a separate module to process these menus. On the other hand, the registered face images of the user having different sub-IDs may be used independently as an individual person when performing the user authentication, or all the registered face images of the user having different sub-IDs may be integrally as those of the same user when performing the user authentication. Therefore, when these face images are used to authenticate the user, the embodiment may chose a case of the face image having the highest authentication score in consideration of the face images as an individual person, may combine several authentication scores, or may deal with the registered face images of the user having different sub-IDs as one information about the same person.

Further details of the method of providing a face recognition service illustrated in FIG. 4 will not be described since the similar or identical description has already been made with reference to FIG. 1 and can be inferred from that description.

The method for a face recognition of the embodiment described in FIG. 4 may be implemented in the form of recording media including instructions executable by a computer, such as applications or program modules that are executed by a computer. The computer readable media may be any available media that can be accessed by a computer and may include volatile and nonvolatile media, and removable and non-removable media. Further, the computer readable media may include any computer storage media and communication media. The computer storage media may include any volatile and nonvolatile media and removable and non-removable storage media that are implemented in any methods or technologies for the storage of information such as data and computer-readable instructions, data structures, program modules, or other data. The communication media may include a transport mechanism or any information delivery media for transmitting computer readable instructions, data structures, program modules or other data of modulated data signal such as carrier waves.

As described above, the method for face recognition in accordance with the embodiment of the present invention may be executed by the application that is installed by default in the terminal (which may include a program included in platforms, operating systems, or the like mounted by default on the terminal), or may be performed by the application (that is, program) that is installed directly on a master terminal by a user through application store server or an application provider server such a Web server, which is associated with the application or the corresponding service. In this sense, the method for a face recognition in accordance with the embodiment of the present invention may be installed by default on the terminal, or may be implemented in an application (i.e., a program) that is directly installed by a user, or may be recorded on a computer-readable recording medium.

Description of the present invention as described above are intended for illustrative purposes, and it will be understood to those having ordinary skill in the art that this invention can be easily modified into other specific forms without changing the technical idea and the essential characteristics of the present invention. Accordingly, it should be understood that the embodiments described above are exemplary in all respects and not limited thereto. For example, respective components described to be one body may be implemented separately from one another, and likewise components described separately from one another may be implemented in an integrated type.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for a face recognition, the apparatus comprising:
an ID assigning unit configured to assign one ID to a user when registering the user so that the ID is mapped to the user;
a sub-ID assigning unit configured to respectively assign sub-IDs to face images of the user which are different from each other so that the sub-IDS are respectively mapped to the face images when the face images are registered;
a mapping table creation unit configured to create a mapping table in which pairs of the ID and the respective sub-IDs are mapped; and
an authentication unit configured to search the mapping table to authenticate the user to provide an authentication result, upon receipt of a request of a user authentication.

2. The apparatus of claim 1, wherein the authentication unit is configured to:
compare the face images of the user that are registered with a subject face image to be used in the user authentication to measure similarities the face images that are registered and the subject face image;
select a similarity having the largest value and compare the largest similarity value to a predetermined threshold similarity value; and
when the selected similarity is equal to or greater than the preset threshold similarity value, authenticate that the user is the registered user.

3. The apparatus of claim 1, wherein the authentication unit is configured to:
compare the face images of the user that are registered with a subject face image to be used in the user authentication to measure similarities between the face images that are registered and the subject face image;
weight the measured similarities, normalize the weighted similarities and compare the normalized similarities to a predetermined threshold similarity value; and
when at least one of the normalized similarities is equal to or greater than the preset threshold similarity value, authenticate that the user is the registered user.

4. The apparatus of claim 1, wherein the authentication unit is configured to perform the user authentication by using at least one subspace technique of PCA (Principal Component Analysis), LDA (Linear Discriminant Analysis), and ICA (Independent Component Analysis) to produce a subspace based on the face images that are registered.

5. The apparatus of claim 4, the authentication unit is configured to:
calculate a distance between the subspace and the subject face image to be used in the user authentication, upon a receipt of a request of a user authentication from the face recognition terminal; and
authenticate that the user is the registered user based on the calculated distance.

6. A method for face recognition, the method comprising:
assigning one ID to a user when registering the user so that the ID is mapped to the user;
assigning sub-IDs to face images of the user which are different from each other respectively so that the sub-IDS are respectively mapped to the face images when the face images are registered;
creating a mapping table in which pairs of the ID and the respective sub-IDs are mapped; and
authenticating the user as the registered user to provide an authentication result by searching the mapping table, upon a receipt of a request of a user authentication.

7. The method of claim 6, wherein the ID and sub-IDs are set by the user through a user interface.

8. The method of claim 6, wherein said authenticating the user comprises:
comparing the face images of the user that are registered with a subject face image to be used in the user authentication to measure similarities between the face images that are registered and the subject face image;
selecting a similarity having a largest value and comparing the largest similarity value to a predetermined threshold similarity value; and
when the selected similarity is equal to or greater than the preset threshold similarity value, authenticating that the user is the registered user.

9. The method of claim 6, wherein said authenticating the user comprises:
comparing the face images of the user that are registered with a subject face image to be used in the user authentication to measure similarities between the face images that are registered and the subject face image;
weighting the similarities, normalizing the weighted similarities and comparing at least one of the normalized similarities to a predetermined threshold similarity value; and
when the normalized similarities is equal to or greater than the preset threshold similarity value, authenticating that the user is the registered user.

10. The method of claim 6, wherein said authenticating the user comprises performing the user authentication by using at least one subspace technique of PCA (Principal Component Analysis), LDA (Linear Discriminant Analysis), and ICA (Independent Component Analysis) to produce a subspace based on the face images that are registered.

11. The method of claim 10, wherein said performing the authentication comprises:
calculating a distance between the subspace and the subject face image to be used in the user authentication, upon a receipt of a request of a user authentication; and
authenticating that the user is the registered user based on the calculated distance.
